(19) United States
(12) Patent Application Publication
(10) Pub. No.: US 2026/0146960 A1
(43) Pub. Date: May 28, 2026

(54) METHOD FOR DETERMINING INDIVIDUAL SCATTERED-RADIATION IMAGES FOR X-RAY IMAGE POINTS TO BE CONSIDERED IN AN X-RAY IMAGE

(71) Applicant: Siemens Healthineers AG, Forchheim (DE)

(72) Inventors: Philipp ROSER, Allston, MA (US); Alexander PREUHS, Erlangen (DE)

(73) Assignee: Siemens Healthineers AG, Forchheim (DE)

(21) Appl. No.: 19/396,762

(22) Filed: Nov. 21, 2025

(30) Foreign Application Priority Data
Nov. 22, 2024 (DE) 10 2024 211 198.8

(51) Int. Cl. G01N 23/046

(52) U.S. Cl. CPC G01N 23/046; G01N 2223/1016; G01N 2223/401; G01N 2223/419; G01N 2223/421

(57) ABSTRACT

One or more example embodiments relates to a computer-implemented method for determining individual scattered-radiation images for X-ray image points to be considered in an X-ray image.

### CROSS-REFERENCE TO RELATED APPLICATION(S)

The present application claims priority under 35 U.S.C. § 119 to Germany Patent Application No. 10 2024 211 198.8, filed Nov. 22, 2024, the entire contents of which is incorporated herein by reference.

Independent of the grammatical term usage, individuals with male, female or other gender identities are included within the term.

### FIELD

One or more example embodiments relates to a computer-implemented method for determining individual scattered-radiation images for X-ray image points to be considered in an X-ray image. One or more example embodiments also relates to a computer-implemented method for training at least one trained model, to a data processing facility (also referred to as a data processing device), to a computer program, and to a data storage medium.

### RELATED ART

In the field of X-ray imaging, scattered radiation has a major impact on the image quality that can be achieved in imaging. For example, in the field of computed tomography, the existence of scattered radiation can lead to streaking artifacts, blurring or low-frequency distortion of the image contrast.

In order to lessen the impact of scattered radiation, an anti-scatter grid, for example, can be arranged in front of the X-ray detector of an imaging modality, thereby reducing the occurrence of scattered radiation artifacts. Anti-scatter grids, however, also intercept some of the primary radiation, which can lead to worse image quality for a given X-ray dose. Conversely, higher X-ray doses may need to be used in order to achieve a given image quality.

In some areas of use such as neurovascular imaging, for instance when examining aneurysms or embolic strokes in the brain, today the use of anti-scatter grids has therefore typically already been abandoned. Scattered radiation artifacts can be reduced in this case by software-based scattered-radiation correction.

Software-based scattered-radiation correction can be performed in principle by simulating the X-ray imaging, for example by solving the Boltzmann transport equation or by a Monte Carlo method. The high computational effort required in the simulation makes such corrections less suitable, however, if imaging is meant to be performed with low latency, so at least approximately in real time, for example for accompanying a medical intervention.

The same problems also arise in what are known as empirical methods, in which an iterative optimization of projection images is performed, which is likewise highly computationally intensive and hence not suitable for real-time use.

For the image optimization, some approaches use scattered-radiation correction via a model trained by machine learning in order to keep the required computational effort to a minimum. Such a model can be used, for example, to determine directly from a projection image an image that is corrected for scattered radiation. The results, however, have an unacceptable image quality. This is especially the case when the model is trained only for a specific configuration of the imaging, for example trained to a specific imaging geometry, specific imaging parameters and/or a specific patient group. Generalization is not readily possible because the image processing in this approach is heavily influenced by the image data sets used for the training.

### SUMMARY

One or more example embodiments define an improved approach for improving the image quality of X-ray acquisitions and/or CT acquisitions. In particular, the approach provided is also intended to make interventional imaging or imaging with low latency possible. Furthermore, it is intended that the approach can be used flexibly for different imaging tasks.

The object is achieved by the independent claims. Preferred embodiments are described in the dependent claims.

### BRIEF DESCRIPTION OF THE DRAWINGS

Advantages and details are presented in the following exemplary embodiments and in the associated drawings, in which, shown schematically:

FIG. 1 shows an exemplary embodiment of an imaging system, which comprises an exemplary embodiment of a processing facility;

FIG. 2a shows a visualization of the scattered radiation originating from an X-ray beam according to one or more example embodiments;

FIG. 2b shows a visualization of the scattered radiation originating from a further X-ray beam according to one or more example embodiments;

FIG. 3 shows a flow diagram of a computer-implemented method for training a trained model and a flow diagram of a computer-implemented method for determining individual scattered-radiation images according to one or more example embodiments;

FIG. 4a shows a representation of an adapted X-ray image based on the photoelectric absorption coefficient according to one or more example embodiments;

FIG. 4b shows a representation of an adapted X-ray image based on the scatter absorption coefficient according to one or more example embodiments; and

FIG. 4c shows a representation of an adapted X-ray image based on the total absorption coefficient according to one or more example embodiments.

### DETAILED DESCRIPTION

According to one or more example embodiments, a computer-implemented method is defined for determining individual scattered-radiation images for X-ray image points to be considered in an X-ray image. The method comprises at least the following steps:
One step comprises obtaining an X-ray image, wherein the X-ray image is acquired via an X-ray detector and comprises a multiplicity of X-ray image points. The X-ray image points are each associated with a detector region of the X-ray detector. A plurality of, or all, the X-ray image points are X-ray image points to be considered.
One step comprises providing an estimation algorithm, which determines, on the basis of the X-ray image, for each of the X-ray image points to be considered an individual scattered-radiation image, which is associated with the individual X-ray image point to be considered. Each individual scattered-radiation image has a multiplicity of scattered-radiation image points, which are each associated with a detector region of the X-ray detector. Image values of the scattered-radiation image points of the individual scattered-radiation image correlate, preferably exclusively, with the intensity of the scattered radiation which, originating from the primary radiation incident on a detector region associated with the particular X-ray image point to be considered, is scattered onto the detector region associated with the particular scattered-radiation image point.
One step comprises determining an individual scattered-radiation image for each of the X-ray image points to be considered by applying the estimation algorithm to the X-ray image.

An X-ray image can be obtained via an acquisition system, for example. The X-ray image, whether two-dimensional or three-dimensional, can be based in particular on X-ray imaging or a simulation of X-ray imaging. The acquisition system can comprise an X-ray source, an X-ray detector, and/or a collimator, which shapes the primary X-ray radiation. The imaging apparatus may be an X-ray imaging apparatus, for example, in which the acquisitions are obtained via X-ray radiation. In particular, it can be a CT device (computed tomography), for instance a C-arm device.

In the context of the present description, an X-ray image has a multiplicity of X-ray image points. Image values of X-ray image points of the X-ray image preferably describe the X-ray intensity or dose received in a detector region associated with the particular image point. In an embodiment, the X-ray image can be an X-ray attenuation image or can be based on an X-ray attenuation image. In this case, image values of X-ray image points of the X-ray image describe the attenuation experienced by primary radiation, i.e. by an X-ray beam, before incidence on a detector region associated with the particular image point.

Regardless of whether used in connection with the description of X-ray image points or with the description below of scattered-radiation image points, the detector region can comprise a single detector pixel or a plurality of detector pixels. The combining of a plurality of detector pixels, for example 2×2 pixels, into an image point is known as “binning”. Binning offers advantages in terms of efficiency in the processing of X-ray images.

In an embodiment, the X-ray image is a two-dimensional X-ray image. In this case, the X-ray image points can be in the form of pixels. Alternatively, the X-ray image can be a three-dimensional X-ray image, in which case the X-ray image points can be in the form of voxels. The same applies to the scattered-radiation image points described below and in general to image points of a cross-sectional image that can be determined, for example, by reconstruction on the basis of X-ray images and/or on the basis of scattered-radiation images. The X-ray image, an individual or total scattered-radiation image, or generally a cross-sectional image can represent a complete acquisition of an object under examination or can be a segment of a larger image.

Some, a plurality of, or all the X-ray image points of the X-ray image are classified as X-ray image points to be considered. The X-ray image points to be considered can represent the entire X-ray image or a sub-region of an X-ray image. In an embodiment, the sub-region defined by the X-ray image points under consideration is a contiguous sub-region. Alternatively, the X-ray image points to be considered can define a plurality of mutually spaced sub-regions of the X-ray image.

The X-ray image points to be considered can be selected, for example, by a preselection rule or a preselection algorithm. For example, only those X-ray image points that have an intensity below and/or above a specified threshold value can be regarded as X-ray image points to be considered. This can make providing individual scattered-radiation images more efficient by dispensing with superfluous computing operations, which contribute little to the gain in knowledge.

The inventive concept includes that the X-ray image undergoes pre-processing before the processing by the estimation algorithm. For example, X-ray image points of the X-ray image can be grouped or combined so that the X-ray image points after the pre-processing represent a combination of the intensity information or dose information originally contained in the X-ray image points. For example, the X-ray image points can be combined into a group of 2×2 X-ray image points for the processing by the estimation algorithm, so that the image value of an X-ray image point after the pre-processing is determined from the image values of a plurality of original X-ray image points. In other words, an additional “binning” can be performed at the level of the X-ray image points in order to improve further the efficiency for the processing of the X-ray image.

The statements made relating to an X-ray image and X-ray image points can be applied likewise to adapted X-ray images and the corresponding X-ray image points of adapted X-ray images.

Likewise, the statements can also be applied to medical images in general, adapted medical images and cross-sectional images.

The term medical images is intended in the broad sense and includes images acquired by an imaging modality for a medical purpose. In particular, the term medical images includes X-ray images, i.e. projection images, and cross-sectional images determined from projection images by reconstruction. Such cross-sectional images are determined in a CT acquisition, for example, by reconstruction based on the X-ray images/projection images. The cross-sectional images can be oriented in the transverse plane, for example.

The intensity of the X-ray radiation measured at a specific region of the X-ray detector has two components: In one case, the intensity represents the primary radiation, i.e. radiation that was emitted by the X-ray source and has not interacted with the object under examination and therefore hits the specific detector region without deflection. In the other case, the measured intensity is caused by scattered radiation, i.e. radiation that was directed originally onto another region of the X-ray detector but was deflected on the way such that it hits the specific region of the X-ray detector.

The primary radiation can be approximated as a straight X-ray beam or as X-rays. On the path from the X-ray source to the X-ray detector, the X-ray beam experiences attenuation, which attenuation can be described by a total attenuation characteristic value. The total attenuation characteristic value can be a linear integral describing the attenuation of the X-ray beam. The total attenuation characteristic value can be a total attenuation coefficient. The X-ray beam can have an original intensity, i.e. an initial number of photons, I₀, and be attenuated in accordance with the Beer-Lambert Law I=I₀e^{Σ}^{ₓ}^{μ}^{ₜₒₜ}^{(x)x}, where μₜₒₜ(x) is a total attenuation coefficient of the object under examination at the position x and describes the total attenuation of the X-ray beam at the position x.

The scattered radiation incident on a certain region of the X-ray detector originates from surrounding X-ray beams, the primary radiation of which is not incident on this same region of the X-ray detector but on surrounding regions.

Hence an X-ray beam that is directed onto a specific region of the X-ray detector produces, as a result of primary radiation, intensity in that same specific region of the X-ray detector. As a result of scattered radiation, an intensity is measurable in other, surrounding regions of the X-ray detector. The regions of the X-ray detector are associated with specific X-ray image points, and therefore an X-ray beam emits primary radiation onto a specific X-ray image point associated with the X-ray beam or onto specific X-ray image points associated with the X-ray beam, and emits scattered radiation onto other X-ray image points.

By applying the estimation algorithm to an X-ray image, it is possible to calculate for X-ray beams to be considered the corresponding distribution of the scattered radiation originating therefrom, where for each X-ray image point to be considered a corresponding individual scattered-radiation image is determined. In other words, by providing an X-ray image as the input quantity/input/input variable for the estimation algorithm and executing the estimation algorithm, for each X-ray image point to be considered an individual scattered-radiation image corresponding to the X-ray image point is generated. So if, for example, the X-ray image comprises 100×100 X-ray image points, and all the X-ray image points are X-ray image points to be considered, a total of 100×100, i.e. 10 000, individual scattered-radiation images are produced. Each individual scattered-radiation image is associated with a specific X-ray image point to be considered.

An individual scattered-radiation image consequently describes for a corresponding X-ray image point to be considered the distribution of the scattered radiation originating from the primary radiation that is incident on a detector region associated with the X-ray image point to be considered. In other words, for an X-ray beam directed onto an X-ray image point to be considered, the corresponding individual scattered-radiation image describes how the scattered radiation originating from the X-ray beam is distributed on the detector.

The individual scattered-radiation image comprises a multiplicity of scattered-radiation image points, which each correspond to a detector region of the X-ray detector. In an embodiment, the number and arrangement of the scattered-radiation image points equal the number and arrangement of the X-ray image points to be considered or the number and arrangement of the X-ray image points. The dimensions of the individual scattered-radiation images preferably equals the dimension of the X-ray image, for instance 2D or 3D. It is also preferred that the sizes of the individual scattered-radiation images equal the size of the X-ray image, for instance the number of pixels or voxels. This simplifies the processing of the individual scattered-radiation images, for instance if the individual scattered-radiation images are meant to be combined or compared with the X-ray images.

The image values of scattered-radiation image points correlate with the intensity of the scattered radiation which, originating from the primary radiation associated with the particular X-ray image point to be considered, is incident on the detector region associated with the particular scattered-radiation image point. The image values represented in an individual scattered-radiation image therefore correlate with the intensity of the scattered radiation originating from an individual straight X-ray beam, namely the X-ray beam associated with the X-ray image point to be considered. The individual scattered-radiation image therefore describes the distribution of the scattered radiation for the individual X-ray image point associated with the individual scattered-radiation image.

The image values of scattered-radiation image points preferably correlate solely with the intensity of the scattered radiation which, originating from the primary radiation associated with the particular X-ray image point to be considered, is incident on the detector region associated with the particular scattered-radiation image point. This means in particular that the image values of the scattered-radiation image point of the individual scattered-radiation image do not depend on, or correlate with, any further primary or scattered radiation. Only the scattered radiation originating from the primary radiation corresponding to the relevant X-ray image point or from the X-ray beam corresponding to the X-ray image point has an influence on the image values of the scattered-radiation image points of the individual scattered-radiation image.

The determined individual scattered-radiation images can be used further in various ways. In an embodiment of the invention, there is providing of the individual scattered-radiation images, displaying of the individual scattered-radiation images, outputting of the individual scattered-radiation images and/or transmitting of the individual scattered-radiation images. Particularly preferably, optimizing the X-ray image on the basis of the individual scattered-radiation images can take place.

The determining of an individual scattered-radiation image for each X-ray image point to be considered simplifies the determining of scattered radiation contained in an X-ray image. The computational effort needed to determine the scattered radiation is reduced, while the accuracy in determining the scattered radiation is improved. The estimate obtained for the scattered radiation can be used, for example, to optimize the X-ray image, in particular to correct imaging artifacts or to improve imaging contrasts. The determining of individual scattered-radiation images involves less computational effort than determining a total estimate of the scattered radiation.

As revealed in more detail below, the determining of individual scattered-radiation images allows the scattered radiation to be used to adapt the representation of the image values of medical images in order to create additional analysis options. In particular, for example, the image values of X-ray image points can be adapted, thereby creating additional analysis options for X-ray images. In particular, the contrasts in an X-ray image can be adapted or material properties of objects under examination can be ascertained more accurately. The same advantage can be achieved if the information contained in the individual scattered-radiation images is used to adapt the representation of cross-sectional images.

In a preferred embodiment, the method can have a further step. The further step comprises determining for at least one X-ray image point and on the basis of the individual scattered-radiation images a total absorption characteristic value, in particular a total absorption coefficient. The total absorption characteristic value can be a linear integral which describes the total absorption of the primary radiation on the total path from the X-ray source to the detector region of the X-ray detector, which detector region is associated with the particular X-ray image point. The total absorption coefficient describes the total absorption of the primary radiation at a certain position in the object under examination. Thus in other words, the total absorption coefficient can be regarded as a special form of a total absorption characteristic value.

The total absorption characteristic value, in particular the total absorption coefficient, is influenced, as already mentioned above, at least by the interaction of the primary radiation with the object under examination and by the scattering of the primary radiation. It can take into account various scattering effects, for instance in particular classical scattering and/or Compton scattering.

The determining of the total absorption characteristic value(s) and/or total absorption coefficient(s) is therefore performed in particular on the basis of the determined individual scattered-radiation images. For example, for this purpose, the information contained in the individual scattered-radiation images can be re-arranged so as to determine the portion of the intensity of an X-ray image point that was caused by scattered radiation. The portion of scattered radiation falling on an X-ray image point can be subtracted from the total intensity in order to obtain the part of the intensity that corresponds to the primary radiation pertaining to the X-ray image point. When analyzing CT acquisitions, this “re-arranging” of the radiation portions can take place in particular in the projection domain.

The intensity value obtained can be converted into an absorption coefficient. As part of the analysis of a CT acquisition, the absorption coefficient(s) can be determined in a cross-sectional image domain which was determined on the basis of the projection domain. For example, the Beer-Lambert Law already explained above can be used for this purpose. The original intensity can be determined. The determined intensity of the primary radiation can be divided by the original intensity. The logarithm of the result can be determined in order then to determine by reconstruction a location-dependent total absorption coefficient.

In other words, for an image point to be considered in the X-ray image can be determined the portion of incident radiation attributable to scattered radiation that originates from X-ray beams associated with the remaining image points of the X-ray image. This scattered radiation that originates from primary radiation other than that pertaining to the X-ray image point can be ignored in the calculation of the intensity of the X-ray image point. In other words, the total absorption coefficient can define the attenuation of the X-ray beam pertaining to the X-ray image point under consideration, i.e. the primary radiation pertaining to the X-ray image point under consideration, which attenuation is caused by interaction with the object under examination and/or by scattering of the X-ray beam.

Optionally, an adapted medical image, in particular an adapted X-ray image or an adapted projection image, can be determined on the basis of the determined total absorption characteristic values, in particular on the basis of the determined total absorption coefficients. For example, the intensity of the X-ray image points of an adapted X-ray image can correlate with the total absorption characteristic value. Alternatively or additionally, the intensity of the image points of a cross-sectional image can correlate with the total absorption coefficient at the particular position of the image point. In particular, the intensity of the image points of the adapted medical image can correlate solely with the total absorption characteristic value pertaining to the image point, i.e. no other technical information is included in the intensity value of the X-ray image points. Alternatively or additionally, an X-ray attenuation image based on the total absorption characteristic values can be determined.

The adapted medical image obtained in this way and based on the total absorption characteristic values has contrast ratios that are altered compared with the original medical image. The altered contrast ratios in particular allow a reduction in scattered radiation artifacts and other image errors caused by scattered radiation, for instance errors such as blurring and insufficient contrast.

In a preferred embodiment, the method additionally comprises the step of determining a total scattered-radiation image on the basis of the individual scattered-radiation images of the respective X-ray image points.

The total scattered-radiation image has a multiplicity of image points, wherein the image values of image points of the total scattered-radiation image equal the intensity of the scattered radiation that is incident in total on a detector region of the X-ray detector, which detector region is associated with the image point. In particular, which primary radiation is the source of the scattered radiation is not relevant here. Thus the total scattered-radiation image describes how the scattered radiation is distributed in total in the X-ray image.

The total scattered-radiation image can be produced, for example, by superposition, i.e. overlaying the individual scattered-radiation images. Other possible ways of determining a total scattered-radiation image are also conceivable, however; for instance a weighted sum of the individual radiation images can be formed.

The adapted medical image can be determined on the basis of the total scattered-radiation image. For example, the total scattered-radiation image can be used in the determining of the adapted medical image in such a way that the adapted medical image is largely cleaned of scattered radiation. In particular, the adapted medical image can be obtained by forming the difference between image values of the original medical image and the total scattered-radiation image. By taking account of the total scattered radiation in determining the adapted medical image, scattered radiation artifacts can be reduced efficiently, leading to improved image quality.

In a preferred embodiment, the method can comprise the step of determining for at least one X-ray image point and on the basis of the individual scattered-radiation images a photoelectric absorption characteristic value, in particular a photoelectric absorption coefficient. The photoelectric absorption characteristic value describes the absorption of the primary radiation by photoelectric absorption on the path from the X-ray source to the detector region of the X-ray detector, which detector region is associated with the particular X-ray image point. In the case that the photoelectric absorption characteristic value is a linear integral, the photoelectric absorption characteristic value describes the photoelectric absorption over the total path from the X-ray source to the X-ray detector. In the case that the photoelectric absorption characteristic value is a photoelectric absorption coefficient, the photoelectric absorption coefficient describes the absorption of the primary radiation by photoelectric absorption at a certain position in the object under examination. In other words, the information contained in the individual scattered-radiation images about the attenuation of the intensity of an X-ray beam by scattering effects is recycled, and the intensity “lost” by scattering is added to the intensity of the primary radiation. Thus the “recycling” eliminates the attenuation of the intensity by scattered radiation, so that solely the attenuation of the X-ray beam as a result of photoelectric absorption is considered.

In particular, the information contained in the individual scattered-radiation images about the scattering of an X-ray beam can be redistributed such that the energy contained in the scattered radiation of the X-ray beam is added to the primary energy of the X-ray beam. In an exemplary embodiment, the sum of the intensities of the scattered-radiation image points is formed, and this sum is added to the intensity of the primary radiation. This approach requires less computational effort but, because of the simple computing operations, cannot model all the radiation effects. For example, Compton radiation or the attenuation of the scattered radiation in the object under examination can be modeled only to a limited extent.

In another embodiment, a weighted sum of the scattered-radiation image points is therefore formed additionally or alternatively. In this case, preferably the intensity of those photons incident on the detector further away from the X-ray image point under consideration is weighted more heavily, for example because these are partially absorbed after the scattering when passing through the object under examination, or some of the photon energy is absorbed by (renewed) Compton scattering.

The determining of the photoelectric absorption characteristic value, in particular of the photoelectric absorption coefficient, can be performed before, after or simultaneously with the determining of the total absorption characteristic value. Similar to determining the total absorption characteristic value, when analyzing a CT acquisition, the linear integral describing the photoelectric absorption characteristic value can be calculated in the projection domain. The photoelectric absorption coefficients at a certain position in the object under examination can be obtained, in particular for a certain image point of a projection image, by reconstruction on the basis of the information in the projection domain.

Hence optionally an adapted medical image can be determined on the basis of the individual scattered-radiation images or on the basis of the photoelectric absorption characteristic values. The image values of the image points of the adapted medical image can be based on the intensity of the primary radiation falling on the corresponding detector region and on the intensity of the scattered radiation originating from the primary radiation. Alternatively or additionally, the image values of the medical image can be based on the photoelectric absorption coefficients. In particular, the image values can be based solely on the photoelectric absorption coefficients. The intensity of the X-ray beam can be expressed as I=I₀e^{Σ}^{ₓ}^{μ}^{ₚₕₒₜₒ}^{(x)x}, where I₀ is the original intensity of the X-ray beam and μₚₕₒₜₒ(x) is the photoelectric absorption coefficient at the position x.

In other words, the X-ray beam corresponding to an X-ray image point is attenuated on the path to the detector both by interaction with the object under examination and by scattered radiation. The attenuation of the X-ray beam by scattered radiation correlates directly with the information represented in the individual scattered-radiation image of the corresponding image point. Thus the scattering-deflected primary radiation of the X-ray beam pertaining to the X-ray image point can be re-associated with the X-ray image point. In particular, the image value and/or the intensity of an image point in the adapted medical image can be adapted such that the image value and/or the intensity correlates with the primary radiation corresponding to the image point and with the scattered radiation originating from the primary radiation corresponding to the image point.

The adapted medical image obtained in this way, which is based in particular on the difference from the total absorption characteristic values and the scatter absorption characteristic values, has contrast ratios that are altered compared with the original X-ray image. The altered contrast ratios in particular allow improved identification and discrimination of objects under examination or parts of objects under examination that have high CT values, for instance bone or contrast agent.

As described above, the photoelectric absorption coefficient μₚₕₒₜₒ(x) is determined on the basis of the total attenuation and the attenuation caused by scattered radiation, in particular by subtracting the attenuation by the scattered radiation from the total attenuation, or addition of the corresponding intensities.

In a preferred embodiment, the method therefore additionally comprises determining, on the basis of the determined individual scattered-radiation images, the determined total absorption coefficients and/or the determined photoelectric absorption coefficients, a scatter absorption characteristic value, in particular a scatter absorption coefficient, for the primary radiation.

If the scatter absorption characteristic value is in the form of a linear integral, the linear integral describes what portion of the X-ray radiation emitted by the X-ray source was scattered in total on the path from the X-ray source to the detector region associated with the image point such that the scattered portion is not incident on the associated detector region. The scatter absorption coefficient of an image point to be considered, in particular of an image point of a cross-sectional image, describes what portion of the X-ray radiation emitted by the X-ray source has been scattered at the position of the image point such that the scattered portion is not incident on the detector region associated with the corresponding X-ray beam. In the underlying X-ray image, this portion of the X-ray radiation is thus not included in the image value of the X-ray image point; in particular, the intensity of the X-ray image point in the original X-ray image does not represent the intensity of the corresponding deflected scattered radiation.

For all the X-ray image points to be considered, i.e. for all the X-ray image points for which an individual scattered-radiation image is determined, can be determined a corresponding scatter absorption characteristic value. This is not absolutely necessary, however, and therefore a scatter absorption coefficient can be determined for additional X-ray image points or for fewer X-ray image points. The same applies to the photoelectric absorption coefficient and the total absorption coefficient.

In a CT acquisition, the determining of the scatter absorption characteristic value can be performed in the projection domain or, after a reconstruction, in the cross-sectional image domain. In particular, the scatter absorption characteristic value can be calculated directly on the basis of the linear integrals.

Alternatively, a reconstruction can first be performed, whereafter the above-described correlation μₚₕₒₜₒ=μₜₒₜ−μ_{sc} can be used to determine the location-dependent scatter absorption coefficient, and the scatter absorption coefficient of an X-ray beam can be determined on the basis of μₚₕₒₜₒ and μₜₒₜ, for instance by determining μ_{sc}=μₜₒₜ−μₚₕₒₜₒ.

The scattered radiation that is scattered on the way to an X-ray image point and not manifested in the image value of the corresponding X-ray image point can be interpreted as misdirected primary radiation, which can allow more precise conclusions to be drawn about the composition of the object under investigation.

In a further preferred embodiment, the method therefore additionally comprises the step of
determining at least one adapted medical image on the basis of the determined scatter absorption coefficient.

After the estimating of the scattered radiation and the determining of a scattered radiation absorption characteristic value, in particular a scattered radiation absorption coefficient, an adapted medical image can be determined on the basis thereof. In the adapted medical image, in particular in an adapted cross-sectional image, the scatter absorption coefficient pertaining to an image point can be included in the image values of the corresponding image points. Thus the image information contained in the scattered radiation can be associated with that image point pertaining to the primary radiation that is the source of the scattered radiation.

For example, the intensity of the image points of the adapted medical image can correlate with the scattered radiation caused by the primary radiation pertaining to the X-ray image point. In particular, the intensity of the image points of the adapted medical image can correlate solely with the scattered radiation pertaining to the image point, i.e. no other technical information is included in the intensity value of the image points. The intensity of the image points of the adapted medical image can correlate additionally or alternatively with the respective scatter absorption coefficients.

The adapted medical image obtained in this way has contrast ratios that are altered compared with the conventional medical image. The altered contrast ratios in particular allow improved identification and discrimination of materials that have a low CT value/CT number/Hounsfield values, for instance soft tissue material.

Preferably, the method additionally comprises the step of determining a further adapted medical image, wherein the adapted medical images are determined on the basis of different absorption characteristic values or absorption coefficients, and/or are determined on the basis of the individual scattered-radiation images, so that the adapted medical images represent different intensity and/or absorption values.

Hence a plurality of adapted medical images can be provided that contain different image information. For example, an adapted medical image can be determined on the basis of, in particular solely on the basis of, the scatter absorption coefficient. A further adapted medical image can be determined on the basis of, in particular solely on the basis of, the photoelectric absorption coefficient. Different view modes for observing an object under examination can thereby be provided to a medical professional without the need for a plurality of X-ray or CT acquisitions of the same object under examination using different settings. When analyzing the medical acquisitions, the medical professional can make comparisons between different view modes, making it easier to identify and/or classify objects under examination.

The estimation algorithm can have different forms. In an embodiment of the invention, the estimation algorithm comprises scatter kernel superposition and/or a Monte Carlo simulation.

In an additional or alternative embodiment, the estimation algorithm comprises a trained model or is a trained model. The model is trained to determine on the basis of an X-ray image having a multiplicity of X-ray image points, for each X-ray image point to be considered, an individual scattered-radiation image, which is associated with the particular X-ray image point to be considered and has a multiplicity of scattered-radiation image points. Image values of the scattered-radiation image points correlate, preferably exclusively or solely, with the scattered radiation which, originating from the primary radiation incident on a detector region associated with the particular X-ray image point to be considered, is scattered onto the detector region associated with the particular scattered-radiation image point.

In general, a trained machine learning method mimics the cognitive functions that humans associate with thought processes of other humans. By training on the basis of training data, the trained model in particular is capable of adapting to new circumstances and recognizing and extrapolating patterns. Another term for “trained model” is “trained function”.

Although trained models can learn complex relationships, it is possible to apply even complex trained models at least approximately in real time. As part of the training, the trained model can thus learn, for example, to provide results that largely correspond to the results of a more complex computational method used during the training, for instance solving the Boltzmann transport equation or a Monte Carlo method. Thus by using a trained model, it is possible to achieve a similarly good estimate to that which might be achieved on the basis of far more complex calculations. Thus, notwithstanding the good estimation quality, it is possible to achieve in particular a quasi-real-time capability to estimate the scattered radiation and in particular correct the X-ray image on the basis thereof. Hence the described procedure can significantly improve, for example, the quality of a scattered-radiation correction during interventional imaging.

The estimation algorithm is physically motivated by the determination of separate individual scattered-radiation images for different X-ray image points to be considered, which means that during the training, and/or directly while the estimation algorithm is being applied, interim results from the estimation algorithm, for example the determined individual scattered-radiation images, can be used to identify and discard physically unrealistic results, for example, or to suppress in the training the generation of such results.

The trained model can be based on a machine learning model. In general, the parameters of a machine learning model can be adapted by training in order to provide the trained model. The training can in particular precede the method according to one or more example embodiments and hence not be part of the method according to one or more example embodiments. Alternatively, it would also be possible to perform the training as additional preceding method steps within the method according to one or more example embodiments.

In particular, supervised training, semi-supervised training, unsupervised training, reinforcement learning and/or active learning can be used. Furthermore, representation learning, which is also known as “feature learning”, can also be employed. In particular, the parameters of the machine learning model can be adapted iteratively by a plurality of training steps. In particular, a specific cost function can be minimized as part of the training. In particular, the backpropagation algorithm can be used in the training, for instance the training of a neural network.

A machine learning model can comprise in particular a neural network, a support vector machine, a decision tree and/or a Bayes network and/or a transformer, and/or the machine learning model can be based on k-means clustering, Q-learning, genetic algorithms and/or association rules. A neural network may be in particular a deep neural network, a convolutional neural network, or a deep convolutional neural network. Moreover, a neural network may be an adversarial network, a deep adversarial network, and/or a generative adversarial network. The machine learning model can have a U-Net architecture and/or a vision transformer architecture.

In a preferred embodiment, the method additionally comprises the step of compressing the determined individual scattered-radiation images via an approximation of a parametric function or a parametric curve to the image values of the scattered-radiation image points.

For example, the parametric curve can be or comprise a B-spline, a polynomial or another base function. The scattered radiation represented by the individual scattered-radiation images has a low frequency, and therefore only a small amount of information is lost in an approximation by a parametric function. Yet the memory space required for storing the individual scattered-radiation images is reduced and the processing of the scattered-radiation images is made more efficient.

The determining of the individual scattered-radiation images can take into account only first-order scattering. As a result, a small number of computing operations have to be executed by the estimation algorithm or when creating the training data for a trained model. Therefore the method needs less computing power for its execution.

The determining of the individual scattered-radiation images can, however, take into account scattering of higher order than first order. Equally, the training of the trained model can take into account scattering higher than first order. In this case, the underlying physical relationships can be modeled more accurately. This results in an increase in the accuracy of the generated individual scattered-radiation images.

One or more example embodiments relates to a computer-implemented method for training at least one trained model. For example, the trained model is intended for use in an estimation algorithm in the computer-implemented method according to one of the preceding embodiments.

The method for training the trained model comprises the step of obtaining training data, wherein the training data comprises a plurality of training data sets of source data and target results. In each case, the source data comprises an X-ray image having a multiplicity of X-ray image points. The corresponding target result comprises for each X-ray image point to be considered in the X-ray image an individual scattered-radiation image associated with the individual X-ray point to be considered. The individual scattered-radiation image is meant to be provided in processing the source data of the particular training data set by the trained model. Image values of scattered-radiation image points of the individual scattered-radiation image correlate with the scattered radiation which, originating from the primary radiation incident on a detector region associated with the particular X-ray image point to be considered, is scattered onto the detector region associated with the particular scattered-radiation image point.

The method additionally comprises training the trained model by supervised learning on the basis of the training data sets.

The method additionally comprises providing the trained model.

Thus the trained model can be based on supervised training using training data sets that each comprise source data and a plurality of target results. The source data can be used directly or after preprocessing as input data for the estimation algorithm. The respective associated target result, in particular an individual scattered-radiation image, is meant to be provided in processing the particular source data by the estimation algorithm. At least the target results can be based here on a simulation of the X-ray imaging, in particular of the scattering of the X-ray radiation.

The simulation of the X-ray imaging or of the scattering of the X-ray radiation can in particular precede the method for training a trained model and/or the method for determining individual scattered-radiation images. Such a simulation of the X-ray imaging can thus form an additional preceding method step of the method described here.

The X-ray imaging and/or the scattering of the X-ray radiation can be simulated, for example, by solving the Boltzmann transport equation, by a Monte Carlo method, and/or by raycasting. In particular, the simulation can use known parameters of a simulated X-ray imaging facility (also referred to as an X-ray imaging system) and a three-dimensional model of an object or patient to be depicted in the simulation. The three-dimensional object can describe in particular a spatial distribution of different materials or of scattering and interaction properties of the depicted material. In the simplest case, such a three-dimensional model can be produced synthetically, so for instance on the basis of an anatomical atlas and known scattering and interaction properties of different body constituent parts, or the model or parts of the model can be generated manually.

In particular, the source data of the particular training data set, so for instance an X-ray image, can also be produced at least in part in such a simulation. Additionally or alternatively, for at least some of the training data sets or else for all the training data sets, X-ray images that are based on actual X-ray imaging can be used as the source data or as the basis for the source data. In this case, the three-dimensional model of the depicted object or patient can be generated on the basis of the image data of the same X-ray imaging in order to determine by simulation of the X-ray imaging, as explained above, the individual scattered-radiation images associated with the particular X-ray image as the target results.

For example, the X-ray image for the particular training data set can be captured as part of computed tomography, whereby the image data from the X-ray imaging describes a three-dimensional depiction of the depicted object or patient. By classifying different image regions, for example by a trained algorithm or by using an anatomical atlas with which the three-dimensional depiction is registered, the different regions of the three-dimensional depiction can then be classified as, for example, tissue, bones, etc., whereby they can be assigned the at least approximately known interaction and scatter properties of the particular material depicted. It is mentioned for the sake of completeness that in principle the interaction and scatter properties of a three-dimensional object can be estimated also from individual X-ray images, where in particular additional information about a known imaging geometry and the object can be used.

In a preferred embodiment, the particular target result can additionally comprise a total scattered-radiation image, which has been determined on the basis of the individual scattered-radiation images associated with the respective X-ray image points. If a total scattered-radiation image is included in the training data in addition to the individual scattered-radiation images provided as the target result, the training of the trained model is improved because more information is available for assessing the training results. In particular, the trained model can provide more accurate and more consistent results.

The training of the trained model preferably comprises optimizing at least one cost function, wherein the value of the cost function depends on image values of the scattered-radiation image points and/or depends on the image values of the image points of the total scattered-radiation image. Particularly preferably, the training of the trained model comprises optimizing a plurality of cost functions, wherein a cost function is determined and optimized for each X-ray image point to be considered, i.e. for each individual scattered-radiation image to be determined. In addition, a further cost function can be determined for a total scattered-radiation image. As mentioned above, the total scattered-radiation image can be based on the individual scattered-radiation images or it can be produced independently of the individual scattered-radiation images by the trained model. In an example, in the case of n×m X-ray image points to be considered, n×m+1 cost functions are thus optimized in the training of the trained model.

Additionally or alternatively, the optimization can be performed under a constraint that evaluates the image values of the scattered-radiation image points and/or the image values of the total scattered-radiation image.

Further features explained in the context of the computer-implemented method according to one or more example embodiments for determining individual scattered-radiation images for X-ray image points to be considered can also be applied, together with the advantages stated there, to the computer-implemented method for training at least one trained model, and vice versa.

In addition, one or more example embodiments relates to a data processing facility (also referred to as a data processing device, which includes processing circuitry), which is configured to perform the computer-implemented method according to one of the exemplary embodiments described above. For example, the data processing facility can be a suitably programmed data processing facility or the stated functionality can be implemented at least in part in the form of hardware. The data processing apparatus can be integrated in a medical imaging facility, in particular an X-ray facility (also referred to as an X-ray system), or be separate therefrom. For example, it can be implemented as a workstation computer, server or Cloud solution.

In addition, one or more example embodiments relates to an X-ray facility having an X-ray source and an imaging X-ray detector, wherein the X-ray facility comprises a data processing facility according to one or more example embodiments. By the integration of a data processing facility according to one or more example embodiments and hence by implementing the method according to one or more example embodiments in an X-ray facility, the explained scattered-radiation estimation, or a scattered-radiation correction based thereon, can be performed directly as part of the data capture or during visualization by the X-ray facility for a user.

One or more example embodiments also relates to a computer program containing instructions which are configured, when executed on a data processing apparatus, to perform the computer-implemented method according to one or more example embodiments.

One or more example embodiments also relates to a computer-readable data storage medium containing instructions which are configured, when executed on a data processing apparatus, to perform the computer-implemented method.

Features discussed in the context of one of the methods according to one or more example embodiments or one of the apparatuses according to one or more example embodiments can also be applied with the stated advantages to the other disclosed subject matter.

The exemplary embodiments described in greater detail below constitute preferred embodiments of the present invention.

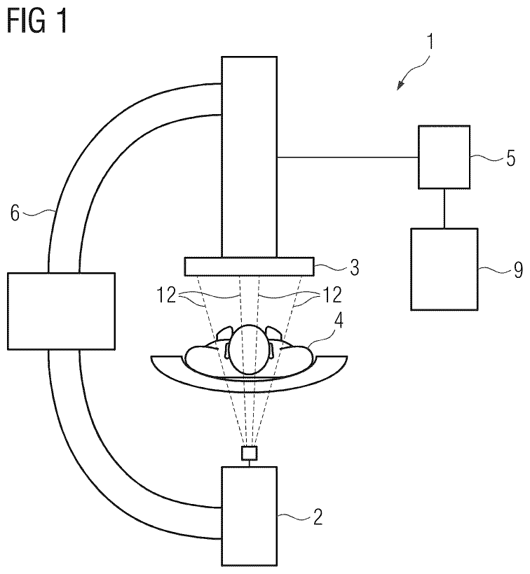

FIG. 1 schematically shows an exemplary embodiment of an imaging system 1 according to the improved concept, which is in the form of an X-ray imaging system by way of example. The example of FIG. 1 shows a design of the X-ray imaging system or device according to the principle of a C-arm device having a rotatable and movable C-arm 6, which can accordingly be rotated and displaced in order to depict from different directions, i.e. at different acquisition angles, an object 4 to be depicted or an object 4 under examination.

An imaging apparatus 1 according to the improved concept can also have different structural designs, however. In particular, the improved concept is not fundamentally restricted to X-ray based imaging methods.

The imaging apparatus 1 of FIG. 1 thus contains by way of example an X-ray source 2, which is configured to produce and emit X-ray radiation towards the object 4 under examination. On an opposite side of the object 4 under examination from the X-ray source 2 is arranged an X-ray detector 3 of the imaging apparatus 1, which X-ray detector contains, for example, a detector array of photodiodes in order to be able to detect X-ray quanta passing through the object 4 under examination. The detector 3 can then transmit the corresponding detector signals to a control or computing unit 5 of the imaging system 1 for further processing. An image processing apparatus 9 can receive acquired images from the control or computing unit 5. The image processing apparatus 9 can perform possible corrections to the acquired images.

The imaging system 1 can be configured, for example, to carry out a rotational angiography method, for instance based on the subtraction-angiography principle. In this case, the computing unit 5 can produce, for example, a multiplicity of two-dimensional projections (also called initial images here) acquired from different angles, and the computing unit 5 can calculate therefrom, if applicable, a three-dimensional reconstruction.

The X-ray radiation attenuated by the material of the object 4 under examination, here a patient, is thus incident on the X-ray detector 3, which comprises a plurality of detector regions 12, and the X-ray intensity or X-ray dose incident in the particular detector region 12 is captured in order to give an image value of a corresponding X-ray image point of an X-ray image.

Since the interaction of the X-ray radiation with the material of the object 4 under examination is not confined to pure absorption of the X-ray radiation, but scattering has also occurred, then scattered radiation is also incident on the X-ray detector 3, which can interfere with the imaging. In addition to, or as an alternative to, reducing the captured scattered radiation by other approaches, for instance by anti-scatter grids, it is therefore expedient to perform an estimate of a scattered-radiation distribution in the X-ray image, in particular in order then to correct the X-ray image according to the determined estimate, for example by subtracting the estimate or by scaling or iterative multiplication of the captured X-ray intensities according to the estimate, and to provide an adapted X-ray image.

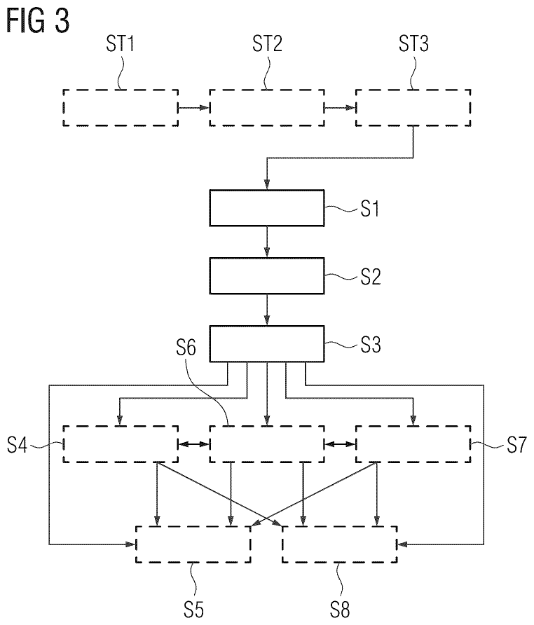

Therefore the processing facility 9 (also referred to as a processing device, which includes processing circuitry), which in the example is integrated in the imaging system 1 but in principle can also be separate therefrom, for instance can be in the form of a workstation, server or Cloud solution, implements a method for determining individual scattered-radiation images. An exemplary embodiment of such a method will be explained below with reference to FIG. 3.

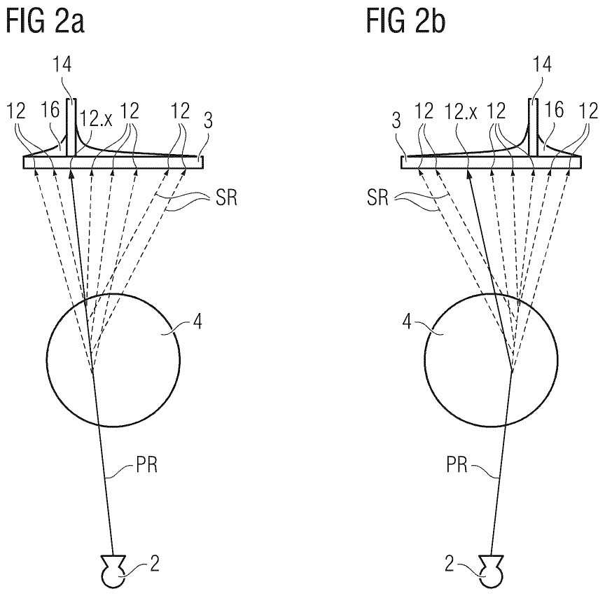

First, however, the principle behind example embodiments is explained briefly with reference to FIGS. 2a and 2b. As already explained in connection with FIG. 1, the imaging system 1 comprises an X-ray source 2, which is used to beam X-ray radiation onto an object 4 under examination. After the object 4 under examination from the viewpoint of the X-ray source 2 is located a detector 3, which has a plurality of detector regions 12. The intensity of the X-ray radiation measured at a specific detector region 12.x comprises two main components: intensity 14 resulting from primary radiation PR and intensity 16 resulting from scattered radiation SR. Therefore in one case, primary radiation PR that is incident on the detector 3 after passing through the object 4 under examination is measured on the specific detector region 12.x (see FIG. 2a).

The primary radiation PR can be approximated by a straight X-ray beam, which is emitted with a certain original intensity at the X-ray source and is attenuated on the path to the detector 3. One cause of the attenuation is photoelectric absorption of the energy through the object 4 under examination. Another cause of the attenuation is scattering of the X-ray beam, with some of the energy of the X-ray beam being deflected from the straight path as a result of the scattered radiation. In FIGS. 2a and 2b, the scattered radiation is represented by the dashed lines. Thus in the specific detector region 12.x is measured in addition to the primary radiation PR the scattered radiation SR which, originating from other X-ray beams, is cast onto the specific detector region 12.x (see FIG. 2b).

The scattered radiation SR originating from primary radiation PR or from an X-ray beam can consequently be regarded as deflected primary radiation PR, which contains information about the structure of the object under examination but is not incident on the detector region 12 that actually corresponds to the primary radiation PR. Thus it is worthwhile to determine for individual detector regions 12 or for the respective X-ray image points of an X-ray image, the scattered radiation originating from the corresponding X-ray beams in order to make information contained in the scattered-radiation distribution usable for optimizing or adapting the X-ray image.

The above-mentioned method for determining individual scattered-radiation images is implemented by a computer program, which is stored, for example, in the memory of the image processing apparatus 9 and is executed by the freely programmable processor thereof.

FIG. 3 shows a flow diagram of an example of a computer-implemented method for training a trained model, and a flow diagram of an example of a computer-implemented method for determining individual scattered-radiation images.

In a step S1, an X-ray image is obtained. The X-ray image is acquired, as stated above, on the basis of the X-ray radiation incident on an X-ray detector 3. The X-ray image has a multiplicity of X-ray image points, which are each associated with a detector region 12 of the X-ray detector.

In a step S2, an estimation algorithm is provided, which is designed to determine individual scattered-radiation images on the basis of the X-ray image obtained. A separate individual scattered-radiation image is produced for each X-ray image point to be considered in the X-ray image. Hence when there are n×m×z X-ray image points to be considered, n×m×z individual scattered-radiation images are produced. An individual scattered-radiation image for an X-ray image point to be considered describes, as stated above, the distribution of the scattered radiation SR that originates from an X-ray beam, the primary radiation PR of which is incident on the X-ray image point to be considered.

The individual scattered-radiation image has a multiplicity of scattered-radiation image points, which are each associated with respective detector regions 12. The image values of the scattered-radiation image points equal the intensity of the scattered radiation SR which, originating from the X-ray beam under consideration, is incident on the corresponding detector region 12.

In a step S3, the provided estimation algorithm is applied to the provided X-ray image in order to determine a multiplicity of individual scattered-radiation images.

Optionally, in a step S4, a total absorption coefficient μtot can be determined for at least one X-ray image point. The total absorption coefficient μtot can be determined, for example in the case of a CT acquisition, directly on the basis of the scattered-radiation images, where optionally a reconstruction can then be performed so that the determined total absorption coefficient μtot can be assigned to image points of cross-sectional images. In particular, the total absorption coefficient μtot can describe the absorption that an X-ray beam experiences at a certain position on its path from the X-ray source 2 to the X-ray detector 3. Each image point of a projection image can be associated with a specific total absorption coefficient μtot. Additionally or alternatively, an X-ray beam can be associated with an, in particular average, total absorption characteristic value. In order to determine the total absorption coefficient μtot, it can be determined on the basis of the individual scattered-radiation images what portion of the total intensity of an X-ray image point is constituted by the intensity 14 of the primary radiation PR, and what portion of the total intensity of the X-ray image point is caused by scattered radiation SR originating from other X-ray beams.

Optionally, in a step S6, a photoelectric absorption coefficient μphoto can be determined. Similar to the total absorption coefficient μtot, the photoelectric absorption coefficient μphoto can be determined directly on the basis of the individual scattered-radiation images, where optionally, a reconstruction can then be performed so that the determined photoelectric absorption coefficients μphoto can be assigned to image points of cross-sectional images. The photoelectric absorption coefficient μphoto describes how large the attenuation of an X-ray beam would be if only the photoelectric absorption of the X-ray beam were taken into account but not the energy loss caused by scattering effects. The photoelectric absorption coefficient μphoto is determined on the basis of the individual scattered-radiation images and, optionally, on the basis of the total absorption coefficient μtot. By analyzing the information about the intensity and distribution of the scattered radiation, which information is contained in the individual scattered-radiation images, it is possible to determine from the individual scattered-radiation images how much energy of the corresponding X-ray beam was diverted by scattering effects.

Optionally, in a step S7, a scatter absorption coefficient μsc can be determined. The scatter absorption coefficient μSc can be determined in particular on the basis of the previously determined total absorption coefficient μtot and the photoelectric absorption coefficient μphoto. In particular, the scatter absorption coefficient μSc can be determined by subtracting the previously determined photoelectric absorption coefficient μphoto from the total absorption coefficient μtot in the cross-sectional image domain, i.e. after a reconstructions step. Alternatively or additionally, however, the scatter absorption coefficient μSc can also be determined on the basis of the individual scattered-radiation images. If the total absorption coefficient μtot and the photoelectric absorption coefficient μphoto have already been determined previously, then the scatter absorption coefficient μSc can be determined simply by forming the difference from the photoelectric absorption coefficient μphoto and the total absorption coefficient μtot. The calculation of the scatter absorption coefficient μSc can be performed in principle before or after the reconstruction of cross-sectional images, although it is preferred to perform a reconstruction first. In other words, the scatter absorption coefficient μSc can be calculated in the projection domain, and afterwards a reconstruction of cross-sectional images can be performed, or a reconstruction can be performed first and then the scatter absorption coefficient μSc determined on the basis of the total absorption coefficient μtot and the photoelectric absorption coefficient μphoto.

Optionally, in a step S5, an adapted medical image, in particular an adapted X-ray image and/or an adapted cross-sectional image, can be produced on the basis of at least one of the determined absorption coefficients. Preferably, in step S8, a further adapted medical image, in particular an adapted X-ray image and/or an adapted cross-sectional image, is produced on the basis of another of the determined absorption coefficients, so that the adapted medical images can be compared with each other.

The heart of the method lies in the use of the estimation algorithm, which preferably comprises, or is in the form of, a trained model. The trained model can be obtained, for example, by a method for training a trained model, as described by the steps ST1, ST2 and ST3. The steps can be executed as a separate method or as part of the method for determining individual scattered-radiation images. The steps ST1, ST2 and ST3 are optional, however, for the method for determining individual scattered-radiation images.

In step ST1 is obtained training data. This preferably includes the generating of training data. The training data comprises source data and target results, where preferably each instance of source data and a plurality of target results form one training data set. The source data is used as the input for the trained model. The source data comprises in particular an X-ray image, which can be embodied as described above. The target results comprise in particular for each image point to be considered in the X-ray image an individual scattered-radiation image, which is associated with the X-ray image point to be considered and gives the distribution of the scattered radiation originating from an X-ray beam associated with the X-ray image point to be considered. In addition, the target results preferably comprise a total scattered-radiation image, which is determined by superposition of the individual scattered-radiation images.

The individual scattered-radiation images, and optionally the total scattered-radiation image, can be determined, for example, by simulation of the scattering of X-ray radiation during the X-ray imaging. In this process can be determined, on the basis of a notional object under examination, the material properties of which are known, how the X-ray radiation is scattered by the object under examination. Said simulation of the scattered radiation can be performed, for example, by applying the Monte Carlo method, which can take into account first-order scattered radiation and/or higher-order scattered radiation.

It is thereby possible to simulate for a given X-ray image, which in an embodiment could likewise be a simulated X-ray image, for each X-ray image point to be considered an individual scattered-radiation image, which represents the distribution of the scattered radiation originating from an X-ray beam associated with the X-ray image point to be considered.

Additionally or alternatively, the individual scattered-radiation images used in the training data sets could be generated at least in part by applying, or on the basis of, the slot scanning technique, which has the advantage that the individual scattered-radiation images are based on real measurements and a model of an object under examination is not required.

In a step ST2, the trained model is trained by preferably supervised learning on the basis of the training data sets. In this process, the model, which initially has not yet been trained, is presented with X-ray images as source data in an iterative process, in which the model generates, on the basis of the source data, individual scattered-radiation images and, optionally, a total scattered-radiation image. For each individual scattered-radiation image and for the optionally provided total scattered-radiation image is provided a cost function, which describes how similar the produced individual scattered-radiation images or total scattered-radiation images are to the target results of the training data set. The weights of the model are adapted based on the cost functions, with the aim of minimizing the cost functions. Thus a backpropagation learning algorithm is preferably applied. For example, after a certain number of learning iterations or if the value of the cost functions lies below a certain threshold value, the training is terminated.

In a step ST3, the trained model is then provided, in particular for use in a method for determining individual scattered-radiation images, as described above.

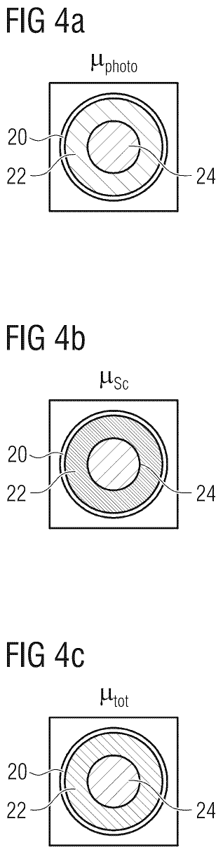

FIGS. 4a, 4b and 4c show a comparison of schematically represented adapted medical images, in this case adapted cross-sectional images, of the same object 4 under examination, where the three adapted cross-sectional images shown have been determined on the basis of different absorption coefficients. The object 4 under examination represented schematically in the cross-sectional images has different materials, in particular bone 20, a tissue constituent 22, for instance brain, and blood 24. The materials of the object 4 under examination interact differently with the X-ray radiation to which they are exposed, which is why different absorption coefficients are evident in the cross-sectional image. Different intensities are detected in different regions 12 of the X-ray detector 3. The different materials are identified by different types of hatching. As can be seen from an overview and comparison of FIGS. 4a to 4c, and as visualized purely schematically by the different types of hatching, the medical images have different contrast ratios. The contrast ratios are mainly dependent on which absorption coefficients are used as the basis for the representation.

The adapted cross-sectional image shown in FIG. 4a is produced on the basis of the photoelectric absorption coefficient μphoto. An adapted cross-sectional image determined on the basis of the photoelectric absorption coefficient μphoto is particularly well suited to distinguishing materials such as bone 20 or contrast agent, because good contrast ratios exist in this representation region.

The adapted cross-sectional image shown in FIG. 4b is produced on the basis of the scatter absorption coefficient μsc. It is evident from the figure that when an adapted cross-sectional image is produced on the basis of the scatter absorption coefficient μSc, the contrast between different soft tissue materials is particularly pronounced, making these materials easy to distinguish.

The adapted cross-sectional image shown in FIG. 4c is produced on the basis of the total absorption coefficient μtot. An adapted cross-sectional image of this type can find a use in particular because scattered radiation artifacts are eliminated here and hence particularly few image errors exist.

The various illustrated logic blocks, modules, circuits and algorithm steps described in connection with the disclosed exemplary embodiments can be implemented as electronic hardware, computer software or combinations of both. In order to demonstrate clearly this interchangeability of hardware and software, various illustrative components, blocks, modules, circuits and steps have been described above generally in terms of their functionality. Whether this functionality is implemented as hardware or software depends on the particular usage to which the overall system is subjected. Persons skilled in the art can implement the described functionality in a different way for each specific usage, but such implementation decisions should not be interpreted as deviating from the scope of this disclosure or of the claims.

Embodiments realized as software can be implemented in software, firmware, middleware, microcode, hardware description languages or in any combination thereof. A code segment or machine-readable instructions can represent a method, a function, a subprogram, a program, a routine, a subroutine, a module, a software package, a class or any combination of instructions, data structures or program instructions. A code segment can be coupled to another code segment or to a hardware circuit by the passing and/or receiving of information, data, arguments, parameters or memory contents. Information, arguments, parameters, data, etc. can be transferred, forwarded or transmitted, for example, by releasing memory, by message-forwarding, token-passing, network transmission, etc.

The actual software code or the specialized control hardware used to implement these systems and methods does not restrict the claimed features or this disclosure. Therefore the operation and behavior of the systems and methods have been described without reference to the specific software code, with the understanding that software and control hardware can be developed in order to implement the systems and methods on the basis of the description herein.

In the implementation as software, functions can be stored as one or more instructions or code on a non-transitory computer-readable or processor-readable storage medium. The steps of a method or algorithm disclosed herein can be embodied in a processor-executable software module, which can be located on a computer-readable or processor-readable storage medium. A non-transitory computer-readable or processor-readable storage medium includes both computer storage media and tangible storage media that make it easier to transfer a computer program from one place to another. A non-transitory processor-readable storage medium can be any available medium that a computer can access. By way of example, but without being restrictive, such non-transitory processor-readable media can include RAM, ROM, EEPROM, CD-ROM or other optical data storage media, magnetic data storage media or other magnetic data storage devices or any other tangible storage medium which can store the desired program code in the form of instructions or data structures and which can be accessed by a computer or processor. Disk/disc, as used here, includes compact disc (CD), laser disc, optical disc, digital versatile disc (DVD), floppy disc and Blu-ray disc, where disks usually reproduce data magnetically and discs reproduce data optically using lasers. Combinations of the above media are also included under computer-readable media. In addition, the operations of a method or algorithm can exist as a, or any, combination or series of codes and/or instructions on a non-transitory processor-readable medium and/or computer-readable medium which can be integrated in a computer program product.

The above description is intended to enable a person skilled in the art to produce and/or use the exemplary embodiments and variants described herein. Various modifications of these exemplary embodiments will be immediately obvious to persons skilled in the art, and the principles defined herein can be applied to other embodiments without departing from the spirit or scope of the subject matter disclosed herein. Therefore, the present disclosure is not intended to be limited to the exemplary embodiments shown here, but should be given the broadest possible scope according to the following claims and the principles and new features disclosed herein.

Although various aspects and exemplary embodiments have been disclosed, other aspects and exemplary embodiments are also envisaged. The various disclosed aspects and exemplary embodiments are for illustrative purposes only and shall not be deemed restrictive, with the true scope and spirit being defined by the following claims.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,“ ”connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

When a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc).

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A computer-implemented method for determining individual scattered-radiation
images for X-ray image points to be considered in an X-ray image, the method comprising:
obtaining an X-ray image, the X-ray image includes a multiplicity of X-ray image points, each of the X-ray image points is associated with a detector region of an X-ray detector used to acquire the X-ray image,
l, the X-ray image points are X-ray image points to be considered;
providing an estimation algorithm, the estimation algorithm determines, based on the X-ray image, an associated individual scattered-radiation image for each of the X-ray image points to be considered,
wherein each individual scattered-radiation image has a multiplicity of scattered-radiation image points, the multiplicity of scattered-radiation image points associated with a detector region of the X-ray detector,
image values of the scattered-radiation image points of the individual scattered-radiation image correlate with an intensity of scattered radiation which, originating from a primary radiation incident on a detector region associated with the X-ray image point to be considered, is scattered onto the detector region associated with the particular scattered-radiation image point; and
determining the associated individual scattered-radiation image for each of the X-ray image points to be considered by applying the estimation algorithm to the X-ray image.

2. The method as claimed in claim 1, further comprising:
determining at least one total absorption characteristic value for at least one X-ray image point based on the individual scattered-radiation images.

3. The method of claim 2, further comprising:
determining at least one adapted medical image based on at least one of the determined individual scattered-radiation images or based on the determined total absorption characteristic values.

4. The method of claim 1, further comprising:
determining a total scattered-radiation image based on the individual scattered-radiation images of the respective X-ray image points.

5. The method of claim 1, further comprising:
determining, for at least one X-ray image point and based on the individual scattered-radiation images, at least one photoelectric absorption characteristic value, the photoelectric absorption characteristic value describing an absorption of primary radiation by photoelectric absorption on a path from an X-ray source to the detector region associated with the particular X-ray image point.

6. The method of claim 1, further comprising:
determining at least one of based on the determined individual scattered-radiation images and total absorption characteristic values, or based on photoelectric absorption characteristic values, a scatter absorption characteristic value.

7. The method of claim 3, further comprising:
determining a further adapted medical image, wherein the at least one adapted medical image is determined based on different absorption characteristic values.

8. The method of claim 1, wherein the estimation algorithm comprises a trained model, wherein the model is trained to determine the associated individual scattered-radiation images.

9. The method of claim 1, further comprising:
compressing the determined individual scattered-radiation images via an approximation of a parametric function to the image values of the scattered-radiation image points.

10. The method of claim 1, wherein the determining of the individual scattered-radiation images takes into account only first-order scattering or takes into account scattering of a higher order than first order.

11. A computer-implemented method for training at least one trained model, for use in the estimation algorithm in the computer-implemented method of claim 1, the method comprising:
obtaining training data, the training data comprising a plurality of training data sets of source data and corresponding target results,
in each set, the source data comprising an X-ray image having a multiplicity of X-ray image points, and the corresponding target result comprising for each X-ray image point to be considered in the X-ray image an individual scattered-radiation image associated with the X-ray point to be considered,
image values of scattered-radiation image points of the individual scattered-radiation image correlating with the scattered radiation which, originating from the primary radiation incident on a detector region associated with the particular X-ray image point to be considered, is scattered onto the detector region associated with the particular scattered-radiation image point; training the trained model by supervised learning based on the training data sets; and
providing the trained model.

12. The method of claim 11, wherein the particular target result additionally comprises a total scattered-radiation image, which has been determined based on the individual scattered-radiation images associated with the respective X-ray image points.

13. A data processing facility, comprising:
processing circuitry configured to perform the computer-implemented method of claim 1.

14. A non-transitory computer-readable medium containing instructions, when executed by a data processing apparatus, cause the data processing apparatus to perform the method of claim 1.

15. The method as claimed in claim 2, the at least one total absorption characteristic value is a total absorption coefficient, which describes a total absorption of primary radiation on a path from an X-ray source to the detector region associated with the X-ray image point.

16. The method of claim 3, wherein the determined total absorption characteristic values are total absorption coefficients.

17. The method of claim 4, wherein an adapted medical image is determined based on the total scattered-radiation image.

18. The method of claim 5, wherein the at least one photoelectric absorption characteristic value is a photoelectric absorption coefficient, and the method further comprises:
determining at least one adapted X-ray image based on the determined photoelectric absorption coefficients.

19. The method of claim 5, further comprising:
determining a further adapted medical image, wherein the at least one adapted medical image is determined based on different absorption characteristic values.

20. The method of claim 6, further comprising:
determining at least one adapted medical image based on the determined scatter absorption characteristic values.
